(19) United States
(12) Patent Application Publication
(10) Pub. No.: US 2018/0324385 A1
(43) Pub. Date: Nov. 8, 2018

(54) STORAGE DEVICE, CONTROL DEVICE, DISPLAY DEVICE, AND STORAGE METHOD

(71) Applicant: Mitsubishi Electric Corporation, Chiyoda-ku, Tokyo (JP)

(72) Inventor: Takayuki SUZUKI, Tokyo (JP)

(73) Assignee: Mitsubishi Electric Corporation, Chiyoda-ku, Tokyo (JP)

(21) Appl. No.: 15/773,246

(22) PCT Filed: Jan. 22, 2016
(86) PCT No.: PCT/JP2016/051941

§ 371 Date: May 3, 2018

(51) Int. Cl. H04N 5/915; H04N 7/18; H04N 5/76

(52) U.S. Cl. CPC H04N 5/915; H04N 5/7605; H04N 7/18

(57) ABSTRACT

A storage device includes a first storage that stores an image of a machine captured by an imaging device in association with time information indicating a timing at which the machine is imaged, and a second storage that stores control information for controlling the machine. The second storage stores the control information in association with the time information, the control information corresponding to a timing at which a control device that controls the machine acquires the time information from the imaging device.

### FIELD

The present invention relates to a storage device, a control device, a display device, and a storage method used in a control apparatus that controls a machine in the field of factory automation (FA).

### BACKGROUND

Equipment in the field of FA is typically implemented by a combination of a plurality of types of machines. The plurality of machines constituting the equipment in the field of FA is connected to a programmable controller which is a controller integrating control processing and information processing together. The programmable controller holds therein data on the state of an input/output signal from an input/output machine and the internal state of the programmable controller. Values of these pieces of data are usually updated every several milliseconds to several seconds in accordance with the control performed by the programmable controller. When a machine controlled by the programmable controller does not operate as intended by the designer of the machine, a change in the value of the data held in the programmable controller is analyzed to debug a control program of the programmable controller or check whether or not there is abnormality in the input/output machine.

### CITATION LIST

### Patent Literature

Patent Literature 1: Japanese Patent Application Laid-open No. 2006-180212

### SUMMARY

### Technical Problem

The technique described in Patent Literature 1 associates measured data with video data on the basis of a base time which is the time when an alarm signal is output. Unfortunately, notification of this base time is made only once. When the notification is made by typical communication means, thus, the base time may shift due to a collision with another communication packet. It is thus difficult for the technique described in Patent Literature 1 to synchronize the video data with the internal data of the controller. As a result, it is difficult to associate the video data with the internal data of the controller.

The present invention has been made in view of the above, and an object of the present invention is to facilitate association between an image captured by an imaging device and internal information of a controller that controls a machine when the controller is analyzed.

### Solution to Problem

In order to solve the above problems and achieve the object, a storage device according to the present invention comprises: a first storage to store a plurality of images of a machine captured by an imaging device, in association with a plurality of pieces of time information each indicating an elapsed time from a reference time; and a second storage to store control information for controlling the machine. The second storage stores the control information in association with the time information, the control information corresponding to a timing at which a control device to control the machine acquires the time information from the imaging device.

### Advantageous Effects of Invention

The present invention has an effect of facilitating the association between the image captured by the imaging device and the internal information of the controller that controls the machine when the controller is analyzed.

### BRIEF DESCRIPTION OF DRAWINGS

FIG. 1 is a diagram illustrating a storage device, an imaging device, a control device, a display device, and a control system according to a first embodiment.

FIG. 2 is a diagram illustrating first information generated by the imaging device according to the first embodiment.

FIG. 3 is a diagram illustrating first information generated by the imaging device according to the first embodiment.

FIG. 4 is a diagram illustrating second information generated by the control device according to a second embodiment.

FIG. 5 is a diagram illustrating the second information generated by the control device according to the second embodiment.

FIG. 6 is a diagram illustrating an image displayed on a display device according to the first embodiment.

FIG. 7 is a flowchart of processing performed at the time of imaging according to the first embodiment.

FIG. 8 is a flowchart illustrating processing of the display device according to the first embodiment.

FIG. 9 is a timing diagram illustrating an image and control information according to the first embodiment.

FIG. 10 is a diagram illustrating a hardware configuration of the storages, the imaging device, the control device, and a display controller according to the first embodiment.

FIG. 11 is a diagram illustrating a hardware configuration of the storages, the imaging device, the control device, and the display controller according to the first embodiment.

FIG. 12 is a diagram illustrating a storage device according to a first variation of the first embodiment.

FIG. 13 is a diagram illustrating a storage device, an imaging device, and a control device according to a second variation of the first embodiment.

FIG. 14 is a diagram illustrating the storage device, the imaging devices, the control device, the display device, and a control system according to the second embodiment.

FIG. 15 is a diagram illustrating pieces of first information generated by the imaging device according to the second embodiment.

FIG. 16 is a diagram illustrating pieces of second information generated by the controller according to the second embodiment.

### DESCRIPTION OF EMBODIMENTS

Embodiment of the present invention will now be described with reference to the drawings. Note that the present invention is not limited to the embodiments.

### First Embodiment

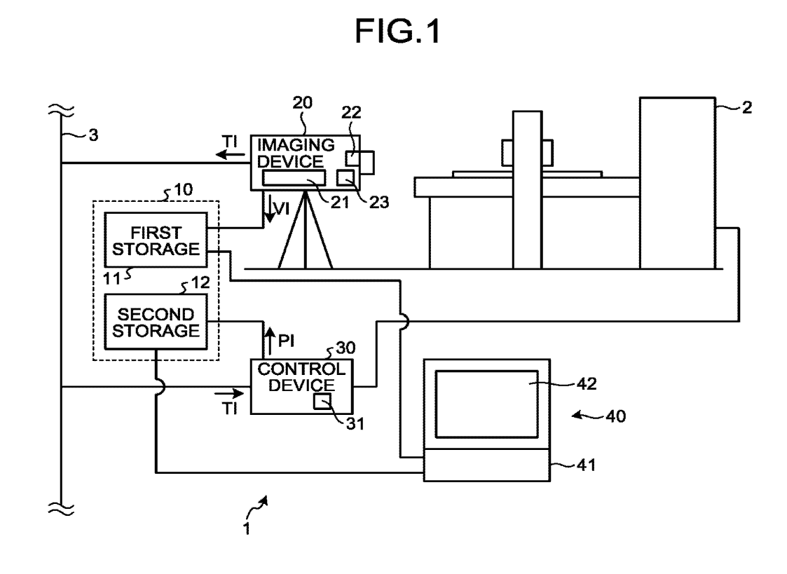

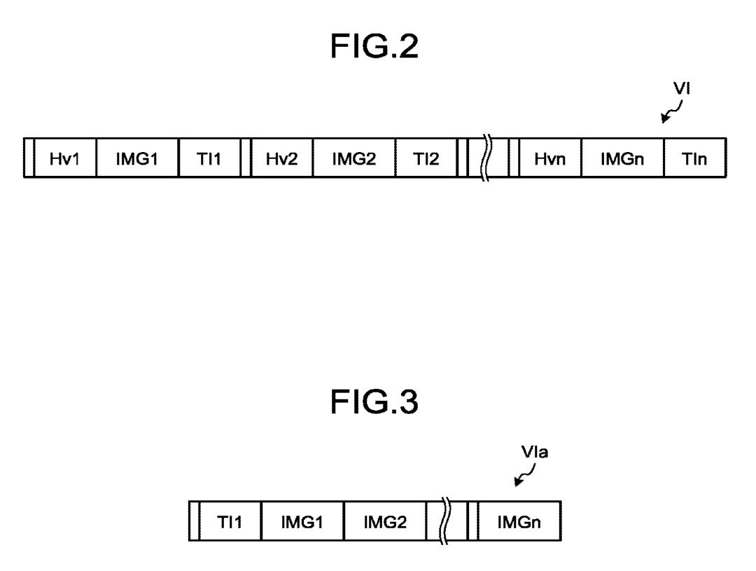

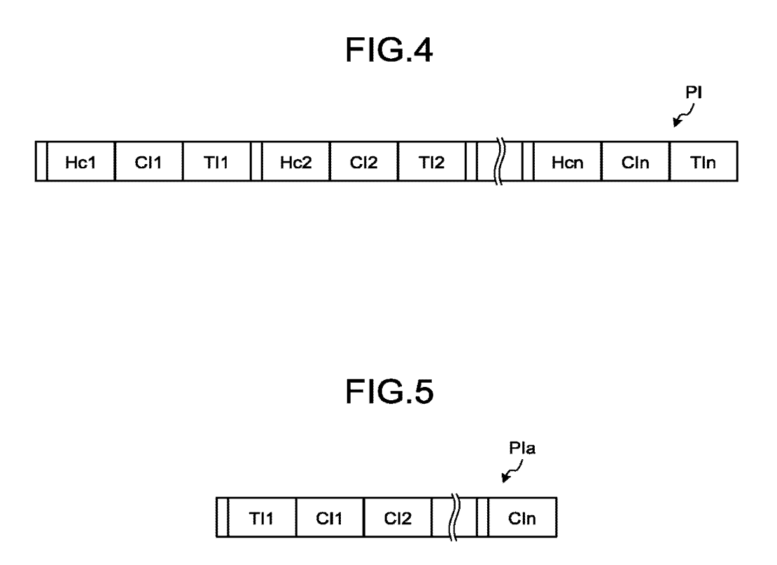

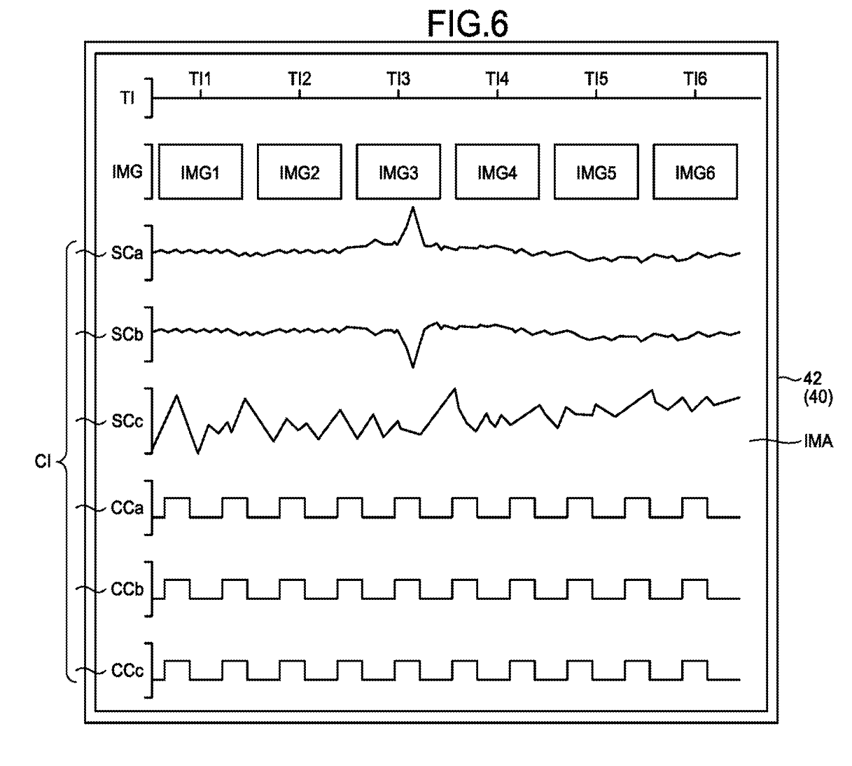

FIG. 1 is a diagram illustrating a storage device 10, an imaging device 20, a control device 30, a display device 40, and a control system 1 according to a first embodiment. FIGS. 2 and 3 are diagrams illustrating first information VI and VIa generated by the imaging device 20 according to the first embodiment. FIGS. 4 and 5 are diagrams illustrating second information PI and PIa generated by the control device 30 according to the first embodiment. FIG. 6 is a diagram illustrating an image displayed on the display device 40 according to the first embodiment.

The control system 1 controls a device or machine 2 in the field of FA. The machine 2 is an element constituting equipment in the field of FA. Examples of the equipment in the field of FA include production equipment, air conditioning equipment, and distribution equipment. Examples of the machine 2 include a machine tool, a machining device, and a conveying device when the equipment is the production equipment. Examples of the machine 2 include an outdoor unit, an indoor unit, and a fan when the equipment is the air conditioning equipment. Examples of the machine 2 include a transporting device and a sorting device when the equipment is the distribution equipment. The equipment and the machine 2 are not limited to the above examples. In the first embodiment, the equipment is the production equipment, and the machine 2 is the machining device.

The control system 1 includes the storage device 10, the imaging device 20, the control device 30, the display device 40, and a communication line 3. The storage device 10 includes a first storage 11 and a second storage 12. The first storage 11 stores a plurality of images of the machine 2 captured by the imaging device 20, in association with a plurality of pieces of time information TI indicating an elapsed time from a reference time. The second storage 12 stores, in time sequence, control information for controlling the machine 2. The second storage 12 stores the control information in association with the time information TI, the control information corresponding to the timing at which the control device 30 controlling the machine 2 acquires the time information TI from the imaging device 20.

The imaging device 20 captures an image of the machine 2. In the first embodiment, the imaging device 20 obtains a plurality of images by imaging the machine 2 in a video imaging mode. A plurality of frames making up the video corresponds to the plurality of images. These images are a plurality of images of the machine 2 obtained in time sequence. At least two or more images may be obtained. In the first embodiment, the imaging device 20 may obtain a plurality of images by capturing the machine 2 a plurality of times in time sequence in a still image capturing mode.

When the control device 30 is analyzed due to the machine 2 operating not as intended by the designer thereof, an image of the operation of the machine 2 captured by the imaging device 20 is associated with the value of internal data held by the control device 30. Thus, the imaging device 20 mainly captures the image of the machine 2 that is in operation.

The imaging device 20 includes an imaging controller 21, an image sensor 22, and a clock 23. The imaging device 20 generates first information VI in which an image obtained by imaging the machine 2 is associated with the time information TI indicating the timing at which the machine 2 is imaged. The imaging device 20 transmits the generated first information VI to the first storage 11 for storage. The first storage 11 receives the first information VI from the imaging device 20 and stores the received information therein. Moreover, the imaging device 20 periodically transmits the time information TI to the control device 30 while imaging the machine 2. In the first embodiment, the imaging device 20 transmits the time information TI to the control device 30 via the communication line 3.

The time information TI is information indicating the elapsed time from the reference time and is also information indicating the timing at which the machine 2 is imaged by the imaging device 20. The time information TI may include the reference time. The time information TI does not have to be the elapsed time itself, but may be an identifier corresponding to the elapsed time from the reference time. When the time information TI is represented by the time at which the machine 2 is imaged, the time indicated by the elapsed time TI may slightly deviate from the time at which the machine 2 is imaged. The elapsed time from the reference time and the time at which the machine 2 is imaged are obtained by the clock 23 or a timer of the imaging device 20.

When the imaging device 20 captures video of the machine 2, the time information TI may be a time code indicating the elapsed time from the reference time or an identifier identifying each frame that makes up the video. The identifier may be a number of the frame. The reference time can be the time at which the imaging device 20 starts imaging the machine 2, for example, but is not limited thereto and may be a certain time during the imaging.

While imaging the machine 2, the imaging device 20 periodically acquires the time from the clock 23 to obtain the time information TI. Thus, a plurality of pieces of the time information TI, that is, at least two pieces thereof, suffices. In the first embodiment, the imaging device 20 acquires the time information TI at regular time intervals from the start of imaging, and associates the time information TI with an image or a frame of video captured when the time information TI is acquired, thereby generating the first information VI. Alternatively, the imaging device 20 may generate the first information VI by using an identifier of the image captured or the frame of the video as the time information TI and associating the image of the time information TI with the time information TI.

As illustrated in FIG. 2, the first information VI includes pieces of delimiter information Hv1, Hv2, . . . Hvn, images IMG1, IMG2, . . . IMGn, and pieces of time information TI1, TI2, . . . TIn. The character “n” is an integer of 1 or more. The numbers 1 and 2 and the character “n” are assigned to distinguish a plurality of pieces of information from one another, and when the plurality of pieces of information need not be distinguished from one another, these numbers and the character are not assigned. In the first information VI, the image IMG and the time information TI are associated with each other. The delimiter information Hv is information that distinguishes one set of the image IMG and the time information TI from another set of the image IMG and the time information TI.

The first information VI is not limited to the one including the pieces of delimiter information Hv1, Hv2, . . . Hvn, the images IMG1, IMG2, . . . IMGn, and the pieces of time information TI1, TI2, . . . TIn. As in first information VIa illustrated in FIG. 3, the information may include only imaging start time TI1 and the images IMG1, IMG2, . . . IMGn as the imaging cycle is fixed at T seconds. In this case, the time at which the image IMG2 is captured is obtained by TI1+T, and the time at which an image IMG3 is captured is obtained by TI1+2×T.

The control device 30 is a device that controls the machine 2. The control device 30 of the first embodiment is a programmable logic controller (PLC). The programmable logic controller is defined by Japan Industrial Standard (JIS) B 3502: 2011. The control device 30 may be any device that controls the machine 2 and is not limited to the programmable logic controller.

Upon acquiring the time information TI from the imaging device 20, the control device 30 generates second information PI by associating control information corresponding to the timing at which the time information TI is acquired, with the acquired time information TI. The control device 30 transmits the generated second information PI to the second storage 12. The second storage 12 stores therein the second information PI transmitted from the control device 30.

In the first embodiment, the timing at which the control device 30 acquires the time information TI is the time at which the control device 30 acquires the time information TI. This time is obtained by a clock 31 or a timer of the control device 30. The timing at which the control device 30 acquires the time information TI need not be the time of acquisition of the time information TI itself but may slightly deviate from the time of acquisition.

As illustrated in FIG. 4, the second information PI includes pieces of delimiter information Hc1, Hc2, . . . Hcn, pieces of control information CI1, CI2, . . . CIn, and the pieces of time information TI1, TI2, . . . TIn. The character “n” is an integer of 1 or more. The numbers 1 and 2 and the character “n” are assigned to distinguish a plurality of pieces of information from one another, and when the plurality of pieces of information need not be distinguished from one another, these numbers and the character are not assigned. In the second information PI, the control information CI and the time information TI are associated with each other. The delimiter information He is information that distinguishes one set of the control information CI and the time information TI from another set of the control information CI and the time information TI.

The second information PI is not limited to the one including pieces of the delimiter information Hc1, Hc2, . . . Hcn, the pieces of control information CI1, CI2, . . . CIn, and the pieces of time information TI1, TI2, . . . TIn. As in second information PIa illustrated in FIG. 5, the information may include only sampling start time TI1 and the pieces of control information CI1, CI2, . . . CIn as the intervals of the time information TI1, TI2, . . . TIn are fixed at T seconds which is identical to the imaging cycle. In this case, the time corresponding to the control information CI2 is obtained by TI1+T, the time corresponding to control information CI3 is obtained by TI1+2×T, and the time corresponding to the control information CIn is obtained by TI1+(n−1)×T.

The control information CI is information used by the control device 30 to control the machine 2 and is internal information of the control device 30. Examples of the control information CI include, but not limited to, input/output information indicating the state of an input/output signal from an input/output device connected to the control device 30, state information indicating the internal state of the control device 30, and a control program. Among the control information CI, values of the input/output information and the state information are updated every several milliseconds to several seconds while the control device 30 controls the machine 2.

The display device 40 includes a display controller 41 and a display 42. The display controller 41 executes control to generate an image to be displayed on the display 42 and then display the image on the display 42. In the first embodiment, the first storage 11 and the second storage 12 are connected to the display controller 41. The display controller 41 acquires from the first storage 11 the first information VI including the image IMG and acquires from the second storage 12 the second information PI including the control information CI.

As illustrated in FIG. 6, the display device 40 simultaneously displays on the display 42 the image IMG of the machine 2 captured by the imaging device 20, and the control information CI for controlling the machine 2. FIG. 6 illustrates an example in which the display device 40 additionally displays the time information TI simultaneously with the image IMG and the control information CI.

The communication line 3 is connected to the imaging device 20 and the control device 30. The imaging device 20 and the control device 30 communicate with each other via the communication line 3. In the first embodiment, at least the imaging device 20 needs to be able to transmit information to the control device 30. In the first embodiment, the imaging device 20 and the control device 30 uses a communication method based on Ethernet (registered trademark) as a method of communication, but the method is not limited thereto. As the method of communication between the imaging device 20 and the control device 30, a communication method based on CC-Link IE Field or a communication method based on AnyWireASLINK may be employed. Next, processing of the imaging device 20 imaging the machine 2 in the first embodiment will be described. This processing corresponds to a storage method according to the first embodiment.

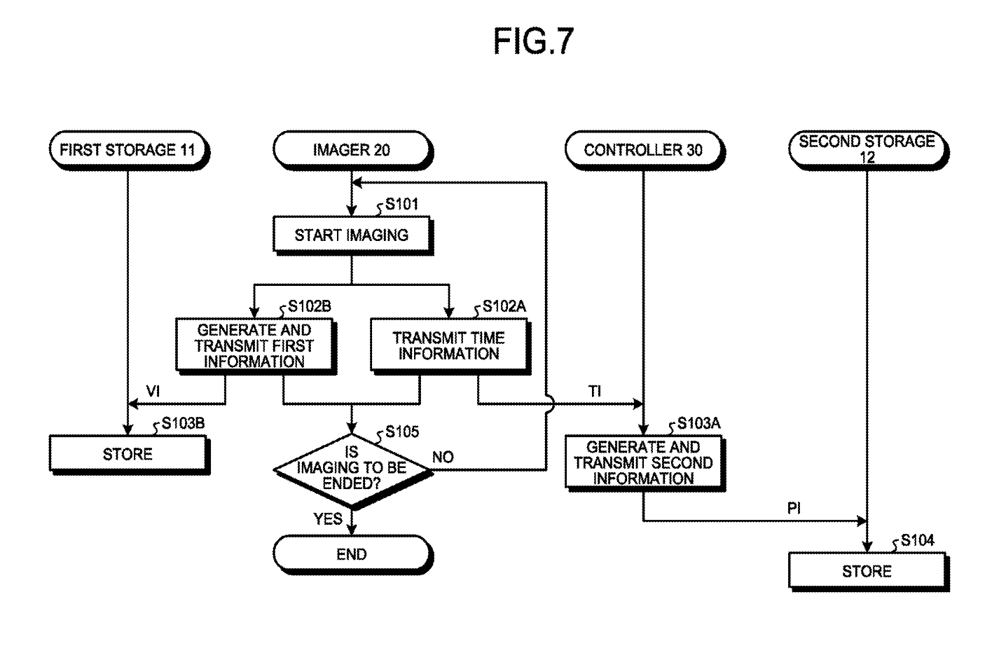

FIG. 7 is a flowchart of the processing performed at the time of imaging according to the first embodiment. In step S101, the imaging device 20 starts imaging the machine 2. The reference time is set to the time at which the imaging device 20 starts imaging the machine 2, but may be set to a timing after the lapse of a certain time from the time at which the imaging is started, or a timing before the imaging is started.

In step S102A, the imaging device 20 transmits the time information TI to the control device 30. Moreover, in step S102B, the imaging device 20 generates the first information VI by associating the above-described image IMG with the time information TI on the timing at which the image IMG is obtained. In step S102B, the imaging device 20 transmits the generated first information VI to the first storage 11.

In step S103A, upon receiving the time information TI transmitted from the imaging device 20, the control device 30 generates the second information PI by using the acquired time information TI and the control information CI corresponding to the time of reception, that is, the timing at which the control device 30 acquires the time information TI. In step S103A, the control device 30 transmits the generated second information PI to the second storage 12.

In step S103B, the first storage 11 receives and stores the first information VI transmitted from the imaging device 20. That is, the first storage 11 stores the image IMG and the time information TI in association with each other.

In step S104, the second storage 12 receives and stores the second information PI transmitted from the control device 30. That is, the second storage 12 stores the control information CI in association with the control information CI corresponding to the timing at which the control device 30 acquires the time information TI from the imaging device 20.

In step S105, the imaging device 20 repeats steps S101 to S105 if an instruction to end imaging is not given to the imaging device 20, or if imaging is not ended (No in step S105). The instruction to end the imaging can be a signal when an imaging switch of the imaging device 20 is turned off. When the control device 30 controls the imaging device 20, the instruction to end the imaging is an instruction transmitted from the control device 30.

In step S105, the imaging device 20 ends the imaging and ends the imaging processing if the instruction to end the imaging is given to the imaging device 20, or if imaging is ended (Yes in step S105).

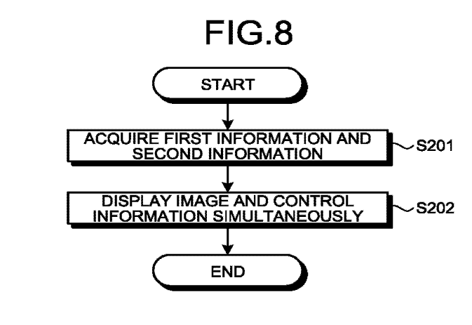

FIG. 8 is a flowchart illustrating processing of the display device 40 according to the first embodiment. In step S201, the display controller 41 of the display device 40 illustrated in FIG. 1 acquires the first information VI from the first storage 11 and acquires the second information PI from the second storage 12. In step S202, the display controller 41 displays the image IMG included in the first information VI and the control information CI included in the second information PI simultaneously on the display 42 of the display device 40, as illustrated in a display image IMA of FIG. 6. The control information CI illustrated in the display image IMA of FIG. 6 includes input values SCa, SCb, and SCc and output values CCa, CCb, and CCc.

The time information TI illustrated in FIG. 6 indicates that as a numerical value attached to the reference sign TI is larger, the image IMG is captured later in time. The display controller 41 displays a plurality of images IMG in time sequence on the display 42. At this time, the display controller 41 also displays the control information CI in time sequence on the display 42 while aligning the positions of the image IMG and the control information CI corresponding to the same time information TI. In the first embodiment, the plurality of images IMG and the control information CI are arranged vertically in the display image IMA. Such a display mode facilitates correlation between the plurality of images IMG and the control information CI. In the first embodiment, the control information CI, which is displayed in the form of a graph in time sequence, allows an operator to easily recognize a change in the control information CI.

The image IMG and the control information CI for the same time information TI correspond to each other, so that the display controller 41 can synchronize the image IMG and the control information CI with each other in time sequence on the basis of the time information TI on the image IMG and the time information TI on the control information CI. The operator can thus recognize a change in the image IMG and the control information CI in time sequence. As a result, the time and effort in finding out the control information CI by referring to the image IMG when there is a failure in the operation of the machine 2, thereby reducing the time and effort in analyzing the control device 30 when a malfunction occurs in the operation of the machine 2.

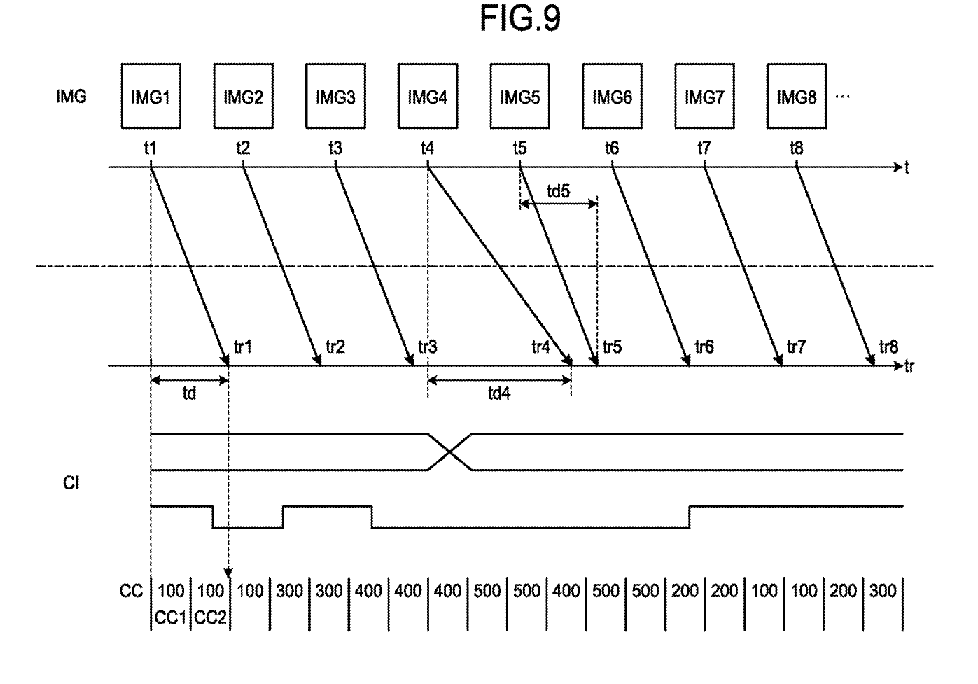

FIG. 9 is a timing diagram illustrating the image IMG and the control information CI according to the first embodiment. Images IMG1, IMG2, . . . IMG8 are obtained at times t=t1, t2, . . . t8, respectively. The time “t” corresponds to the time information TI. In the first embodiment, the control device 30 acquires the time information TI from the imaging device 20 by communication via the communication line 3. The communication may be delayed or have an error that causes information to be not received properly.

When a delay occurs in the communication between the control device 30 and the imaging device 20, the time information TI corresponding to the image IMG1 captured at the time t1 is acquired by the control device 30 at a reception time tr=tr1 which is later than the time t1 by a delay time td. In the second information PI, the control information CI at the timing of acquisition of the time information TI is associated with the time information TI. Thus, the control information CI included in the second information PI is the control information CI corresponding to the reception time tr later than the time t by the delay time td, the time t being a time when the time information TI is transmitted.

In the example illustrated in FIG. 9, the image IMG1 corresponds to an output value CC=CC1 of the control information CI, but the control device 30 acquires the time information TI at the reception time tr=tr1. Since the reception time tr1 is later than the time t1 by the delay time td, the control information CI associated with the time information TI has the output value CC=CC2. The delay time td in communication is usually small, and thus the image IMG is substantially in synchronization with the control information CI. Moreover, the delay time td in communication being usually small, a misalignment between the image IMG and the control information CI is so small that the control information CI corresponding to the image IMG at a certain time t is located in the vicinity of the image IMG. As a result, the operator can easily identify the control information CI corresponding to the image IMG in association therewith.

Although the length of the delay time td varies depending on the state of communication, the delay time td that is long causes the control information CI to be out of synchronization with the image IMG to a large extent. In the example illustrated in FIG. 9, a delay time td4 taken for the time information TI corresponding to the image IMG4 captured at the time t4 to reach the control device 30 is longer than the delay time before the image IMG4. For this reason, the image IMG4 is out of synchronization with the control information CI to a large extent. When a delay time td5 for the image IMG5 recovers to be in the same range as that before the image IMG4, the image IMG5 is less out of synchronization with the control information CI than the image IMG4 is.

The imaging device 20 periodically transmits the time information TI at the time of capturing the image IMG to the control device 30 as described above, whereby the operator can easily associate the image IMG with the control information CI even when a communication delay causes a misalignment between the image IMG and the control information CI. When the time information TI is not received properly due to an error as well, the time information TI different from the time information TI not received is transmitted from the imaging device 20 and properly received by the control device 30, so that the correspondence between the image IMG and the control information CI is obtained on the basis of the correct time information TI. As a result, the control system 1 can easily associate the image IMG with the control information CI in synchronization with each other even when a communication delay occurs.

Although the imaging device 20 periodically transmits the time information TI to the control device 30 in the first embodiment, the time information TI may be transmitted at fixed time intervals as described above or at irregular time intervals. Next, a hardware configuration of the storage device 10, the imaging controller 21, the control device 30, and the display controller 41 will be described.

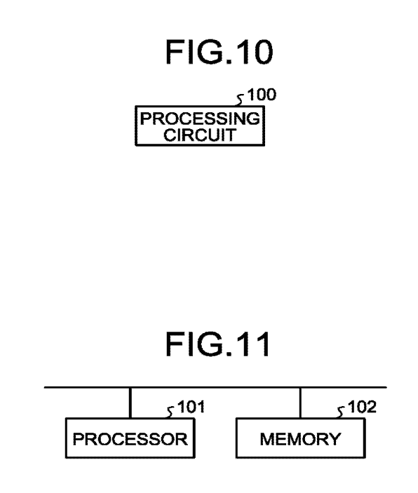

FIGS. 10 and 11 are diagrams illustrating hardware configurations of the first storage 11, the second storage 12, the imaging controller 21, the control device 30, and the display controller 41 according to the first embodiment. A processing circuit 100 illustrated in FIG. 10 implements the functions of the first storage 11, the second storage 12, the imaging controller 21, the control device 30, and the display controller 41.

The function of the first storage 11 is to store the first information VI in which the image IMG and the time information TI are associated with each other as described above. Specifically, the function of the first storage 11 is to acquire the first information VI from the imaging device 20 and store the acquired information in a memory. The function of the second storage 12 is to store the second information PI in which the time information TI and the control information CI are associated with each other as described above. Specifically, the function of the second storage 12 is to acquire the second information PI from the control device 30 and store the acquired information in a memory.

The functions of the imaging controller 21 are to cause the image sensor 22 to image the machine 2, to perform image processing on the captured image, and to transmit the time information TI to the control device 30. The functions of the control device 30 are to control the machine 2 and to generate the second information PI by associating the control information CI with the time information TI acquired from the imaging device 20 and store the second information PI in the second storage 12. The function of the display controller 41 is to acquire the first information VI from the first storage 11 and the second information PI from the second storage 12 to simultaneously display on the display 42 the image IMG and the control information CI corresponding to the same time information TI.

The processing circuit 100 may be dedicated hardware or a processor 101 (a central processing unit (CPU), a processing unit, an arithmetic unit, a microprocessor, a microcomputer, a processor, or a digital signal processor (DSP)) that executes a program stored in a memory 102, as illustrated in FIG. 11.

When implemented as dedicated hardware, the processing circuit 100 corresponds to, for example, a single circuit, a composite circuit, a programmed processor, a parallel-programmed processor, an application specific integrated circuit (ASCI), a field programmable gate array (FPGA), or a combination of those.

When the processing circuit 100 is the processor 101 illustrated in FIG. 11, the functions of the first storage 11, the second storage 12, the imaging controller 21, the control device 30, and the display controller 41 are implemented by software, firmware, or a combination of software and firmware. The software and firmware are described as programs and stored in the memory 102. The processor 101 reads the programs stored in the memory 102 and executes these programs to thereby implement the functions of the first storage 11, the second storage 12, the imaging controller 21, the control device 30, and the display controller 41.

It can also be said that these programs cause a computer to execute control procedure and method according to the first embodiment. The memory 102 corresponds to, for example, a non-volatile or volatile semiconductor memory such as a random access memory (RAM), a read only memory (ROM), a flash memory, an erasable programmable read only memory (EPROM), or an electrically erasable programmable read only memory (EEPROM), a magnetic disk, a flexible disk, an optical disk, a compact disc, a mini disc, or a digital versatile disc (DVD).

Note that the functions of the first storage 11, the second storage 12, the imaging controller 21, the control device 30, and the display controller 41 may be implemented partially by dedicated hardware and partially by software or firmware.

The processing circuit 100 can thus implement the functions of the first storage 11, the second storage 12, the imaging controller 21, the control device 30, and the display controller 41 by hardware, software, firmware, or a combination thereof.

Storage According to First Variation of First Embodiment.

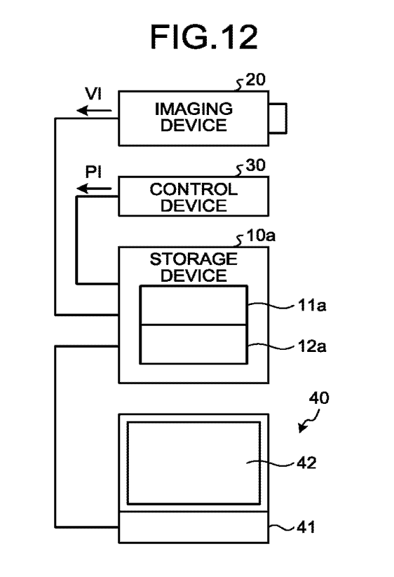

FIG. 12 is a diagram illustrating a storage device 10a according to a first variation of the first embodiment. The imaging device 20, the control device 30, and the display device 40 are similar to the imaging device 20, the control device 30, and the display device 40 of the first embodiment. The storage device 10a of the first variation includes a first storage unit 11a and a second storage unit 12a. The first storage unit 11a stores the first information VI transmitted from the imaging device 20. The second storage unit 12a stores the second information PI transmitted from the control device 30. The display controller 41 of the display device 40 acquires the first information VI from the first storage unit 11a and acquires the second information PI from the second storage unit 12a. The display controller 41 then simultaneously displays on the display 42 of the display device 40 the image IMG included in the first information VI and the control information CI included in the second information PI.

In the first embodiment, the display controller 41 arranges the image IMG and the control information CI such that the image IMG and the control information CI corresponding to the same time information TI are arranged at the same position on a time axis. In the example illustrated in FIG. 6, the time axis is an axis indicating the lapse of time determined by the time information TI. Such a display allows an operator to easily associate the image IMG with the control information CI. The image IMG and the control information CI are arranged vertically in the first embodiment but may be arranged side by side.

The first storage unit 11a and the second storage unit 12a of the storage device 10a are different storage areas in the single storage device 10a. Although the storage device 10 of the first embodiment includes a total of the two storages, namely the single first storage 11 and the single second storage 12, as illustrated in FIG. 1, the single storage device 10a according to the variation suffices. Thus, the installation space and the cost of the storage device 10a can be reduced.

Storage According to Second Variation of First Embodiment.

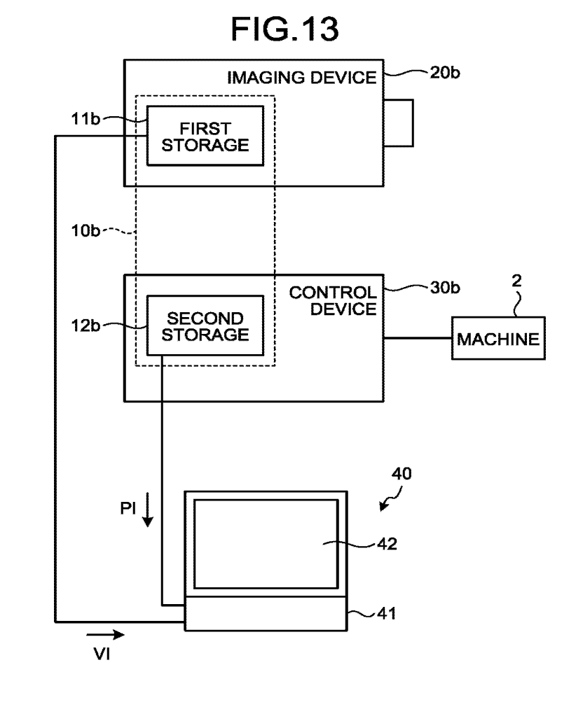

FIG. 13 is a diagram illustrating a storage device 10b, an imaging device 20b, and a control device 30b according to a second variation of the first embodiment. The first storage 11 and the second storage 12 are the devices separate from the imaging device 20 and the control device 30 in the first embodiment, whereas in a second variation, a first storage 11b and a second storage 12b of the storage device 10b are provided inside the imaging device 20b and the control device 30b, respectively.

The display controller 41 of the display device 40 acquires the first information VI from the first storage 11b and acquires the second information PI from the second storage 12b. The display controller 41 then simultaneously displays on the display 42 of the display device 40 the image IMG included in the first information VI and the control information CI included in the second information PI.

The first storage 11b is provided inside the imaging device 20b, and the second storage 12b is provided inside the control device 30b. The installation space of the storage device 10b can thus be reduced.

The hardware configuration of the control device 30b according to the second variation is illustrated in FIGS. 10 and 11. The processor 101 which is a processing unit of the control device 30b controls the machine 2 by using the control information CI. The memory 102 which is a storage unit of the control device 30b stores the control information CI in time sequence. The processor 101 of the control device 30b acquires the time information TI from the imaging device 20b, and the memory 102 of the control device 30b stores the control information CI corresponding to the timing at which the processor 101 acquires the time information TI, in association with the acquired time information TI. The control device 30b of the second variation acquires the time information TI from the imaging device 20b of the second variation, but may acquire the time information TI from the imaging device 20 of the first embodiment.

Example of Considering Delay Time td in Communication.

As described above, the delay time td occurs in communication between the imaging device 20 and the control device 30. When an average delay time td is obtained in advance and stored in the memory of the display controller 41, the display controller 41 may display the image IMG and the control information CI on the display 42 such that the display controller 41 displays the control information CI at a position corresponding to the earlier time shifted by the average delay time td. In the example illustrated in FIG. 6, the display controller 41 displays the control information CI on the display 42 by moving the control information to the left in FIG. 6 or to the side at which the time information TI indicates earlier time. This allows the more accurate synchronization between the image IMG and the control information CI, thereby further reducing the time and effort in finding out the control information CI with reference to the image IMG when there is a failure in the operation of the machine 2. As a result, the time and effort required of an operator in analyzing the control device 30 when a problem occurs in the operation of the machine 2 is further reduced.

The configurations of the first embodiment and its variations can also be applied as appropriate in the following embodiment.

### Second Embodiment

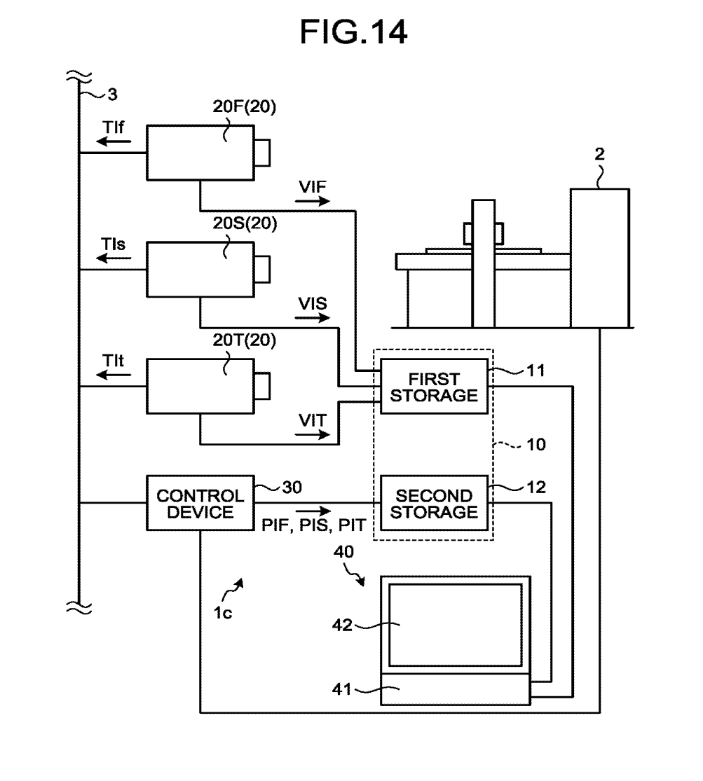

FIG. 14 is a diagram illustrating the storage device 10, imaging devices 20F, 20S, and 20T, the control device 30, the display device 40, and a control system 1c according to a second embodiment.

The machine 2 is imaged by the one imaging device 20 as illustrated in FIG. 1 in the first embodiment, whereas the second embodiment is different therefrom in that the machine 2 is imaged by the plurality of imaging devices 20F, 20S, and 20T. Each of the imaging devices 20F, 20S, and 20T is similar to the imaging device 20 of the first embodiment. Although the three imaging devices 20F, 20S, and 20T image the machine 2 in the second embodiment, the number of imaging devices is not limited to three but may be two or more.

The imaging devices 20F, 20S, and 20T are connected to the communication line 3 to communicate with the control device 30 connected to the communication line 3. The imaging devices 20F, 20S, and 20T transmit pieces of time information TIF, TIS, and TIT to the control device 30 via the communication line 3. The imaging devices 20F, 20S, and 20T are connected to the first storage 11 of the storage device 10 and transmit pieces of first information VIF, VIS, and VIT to the first storage 11, respectively. The first storage 11 stores the pieces of first information VIF, VIS, and VIT each obtained from the corresponding one of imaging devices 20F, 20S, or 20T.

Upon acquiring the pieces of time information TIF, TIS, and TIT from the imaging devices 20F, 20S, and 20T, the control device 30 generates each of second information PIF, PIS, and PIT for the corresponding one of the imaging devices 20F, 20S, and 20T and transmits the generated information to the second storage 12. That is, each of the pieces of the second information PIF, PIS, and PIT is obtained for the corresponding one of the imaging devices 20F, 20S, and 20T.

The second storage 12 stores the corresponding one of the pieces of second information PIF, PIS, or PIT transmitted from the control device 30 for each of the imaging devices 20F, 20S, and 20T. The second information PIF associates the time information TIF transmitted from the imaging device 20F with control information CI corresponding to the timing at which the control device 30 acquires the time information TIF. The second information PIS associates the time information TIS transmitted from the imaging device 20S with control information CI corresponding to the timing at which the control device 30 acquires the time information TIS. The second information PIT associates the time information TIT transmitted from the imaging device 20T with control information CI corresponding to the timing at which the control device 30 acquires the time information TIT.

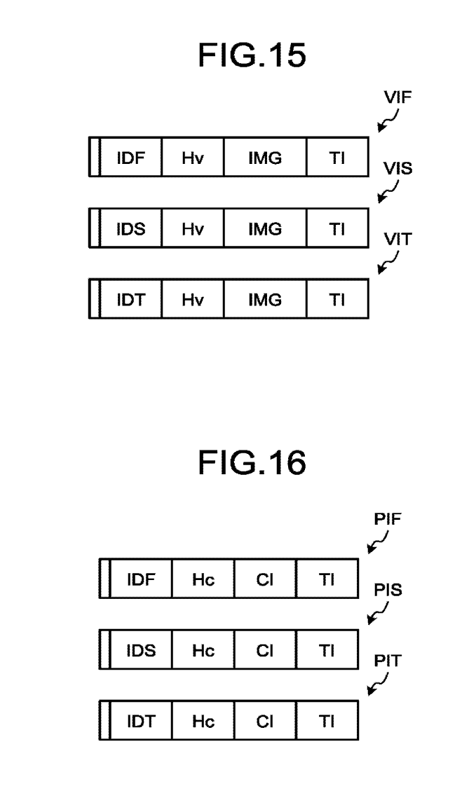

FIG. 15 is a diagram illustrating the pieces of first information VIF, VIS, and VIT generated by the imaging devices 20F, 20S, and 20T according to the second embodiment. The first information VIF output from the imaging device 20F includes an identifier IDF indicating that an image IMG captured by the imaging device 20F is included in the information VIF. The first information VIS output from the imaging device 20S includes an identifier IDS indicating that an image IMG captured by the imaging device 20S is included in the information VIS. The first information VIT output from the imaging device 20T includes an identifier IDT indicating that an image IMG captured by the imaging device 20T is included in the information VIT.

FIG. 16 is a diagram illustrating the pieces of second information PIF, PIS, and PIT generated by the control device 30 according to the second embodiment. The second information PIF includes the identifier IDF indicating that the time information TIF transmitted from the imaging device 20F is included in the information PIF. The second information PIS includes the identifier IDS indicating that the time information TIS transmitted from the imaging device 20S is included in the information PIS. The second information PIT includes the identifier IDT indicating that the time information TIT transmitted from the imaging device 20T is included in the information PIT.

The display controller 41 of the display device 40 illustrated in FIG. 14 simultaneously displays on the display 42 of the display device 40 the image IMG included in the first information VIF having the identifier IDF, and the control information CI included in the second information PIF having the identifier IDF. The display controller 41 simultaneously displays on the display 42 of the display device 40 the image IMG included in the first information VIS having the identifier IDS, and the control information CI included in the second information PIS having the identifier IDS. The display controller 41 simultaneously displays on the display 42 of the display device 40 the image IMG included in the first information VIT having the identifier IDT and the control information CI included in the second information PIT having the identifier IDT.

The display controller 41 displays, on the display 42, at least one of a combination of the control information CI and the image IMG captured by the imaging device 20F, a combination of the control information CI and the image IMG captured by the imaging device 20S, and a combination of the control information CI and the image IMG captured by the imaging device 20T.

The control system Ic of the second embodiment can image the machine 2 at a plurality of angles by using the imaging devices 20F, 20S, and 20T. This further reduces the time and effort in finding out the control information CI by referring to the image ING when there is a failure in the operation of the machine 2, thereby further reducing the time and effort in analyzing the control device 30 when a malfunction occurs in the operation of the machine 2.

The configuration illustrated in the above embodiments merely illustrates an example of the content of the present invention, and can thus be combined with another known technique or partially omitted and/or modified without departing from the scope of the present invention.

### REFERENCE SIGNS LIST

1, 1c control system; 2 device; 3 communication line; 10, 10a storage device; 11, 11b first storage; 11a first storage unit; 12, 12b second storage; 12a second storage unit; 20, 20b, 20F, 20S, 20T imaging devices; 30, 30b control device; 40 display device; 41 display controller; 42 display; 100 processing circuit; 101 processor; 102 memory; CI control information; IMG image; PI second information; TI time information; VI first information.

1: A storage device comprising:
a first storage to store a plurality of images of a machine captured by an imager, in association with a plurality of pieces of time information each indicating an elapsed time from a reference time; and
a second storage to store control information for controlling the machine, wherein
the second storage stores the control information in association with the time information, the control information corresponding to a timing at which a controller to control the machine acquires the time information from the imager, and
the imager periodically transmits the time information to the controller.

2: The storage device according to claim 1, wherein the controller acquires the time information from the imager by communication.

3: The storage device according to claim 1, wherein the second storage is provided in the controller.

4: The storage device according to claim 1, wherein the first storage stores, for each of a plurality of the imagers, a plurality of images of the machine each captured by a corresponding one of the imagers, in association with a plurality of pieces of time information each indicating an elapsed time from a reference time; and
the second storage stores the control information in association with the time information for each of the imagers, the control information corresponding to a timing at which the controller to control the machine acquires the time information from a corresponding one of the imagers.

5: A control device comprising:
a processor to control a machine by using control information for controlling the machine; and
a storage to store the control information for controlling the machine, wherein
the processor acquires, from an imager, a plurality of pieces of time information each indicating an elapsed time from a reference time,
the storage stores the control information in association with the acquired time information, the control information corresponding to a timing at which the processing unit acquires the time information, and
the imager periodically transmits the time information to the processor.

6: The control device according to claim 5, wherein
the processor acquires the time information from the imager by communication.

7: The control device according to claim 5, wherein the storage stores the control information in association with the time information for each of a plurality of the imagers, the control information corresponding to the timing at which the processing circuitry to control the machine acquires the time information from a corresponding one of the imagers.

8: A display device to acquire:
first information in which a plurality of images of a machine captured by an imager is associated with a plurality of pieces of time information each indicating an elapsed time from a reference time; and
second information in which control information for controlling the machine is associated with the time information, the control information corresponding to a timing at which a controller to control the machine acquires the time information from the imager, wherein
the image and the control information corresponding to the same time information are displayed simultaneously, and
the imager periodically transmits the time information to the controller.

9: The display device according to claim 8, wherein the plurality of images is arranged in time sequence and displayed, and the control information is displayed in time sequence with a position of the image and a position of the control information corresponding to the same time information being aligned with each other.

10: The display device according to claim 8, wherein the machine is imaged by a plurality of the imagers, and the first information and the second information are obtained for each of the imagers.

11: A storage method comprising
imaging a machine controlled by a controller;
storing, in a storage, a plurality of the captured images of the machine in association with a plurality of pieces of time information each indicating an elapsed time from a reference time, and transmitting the time information to the controller; and
storing control information for controlling the machine, in association with the time information, the control information corresponding to a timing at which the time information is acquired, wherein
the time information is periodically transmitted to the controller.

12: The storage device according to claim 2, wherein the second storage is provided in the controller.

13: The storage device according to claim 2, wherein the first storage stores, for each of a plurality of the imagers, a plurality of images of the machine each captured by a corresponding one of the imagers, in association with a plurality of pieces of time information each indicating an elapsed time from a reference time; and
the second storage stores the control information in association with the time information for each of the imagers, the control information corresponding to a timing at which the controller to control the machine acquires the time information from a corresponding one of the imagers.

14: The storage device according to claim 3, wherein the first storage stores, for each of a plurality of the imagers, a plurality of images of the machine each captured by a corresponding one of the imagers, in association with a plurality of pieces of time information each indicating an elapsed time from a reference time; and
the second storage stores the control information in association with the time information for each of the imagers, the control information corresponding to a timing at which the controller to control the machine acquires the time information from a corresponding one of the imagers.

15: The storage device according to claim 12, wherein the first storage stores, for each of a plurality of the imagers, a plurality of images of the machine each captured by a corresponding one of the imagers, in association with a plurality of pieces of time information each indicating an elapsed time from a reference time; and
the second storage stores the control information in association with the time information for each of the imagers, the control information corresponding to a timing at which the controller to control the machine acquires the time information from a corresponding one of the imagers.

16: The control device according to claim 6, wherein the storage stores the control information in association with the time information for each of a plurality of the imagers, the control information corresponding to the timing at which the processing unit to control the machine acquires the time information from a corresponding one of the imagers.

17: The display device according to claim 9, wherein the machine is imaged by a plurality of the imagers, and the first information and the second information are obtained for each of the imagers.
